(19) United States
(12) Patent Application Publication
(10) Pub. No.: US 2011/0302717 A1
(43) Pub. Date: Dec. 15, 2011

(54) Bed sheet with indicia and method

(76) Inventor: Stephanie Campasano, Holmdel, NJ (US)

(21) Appl. No.: 12/802,793

(22) Filed: Jun. 14, 2010

(51) Int. Cl. A47G 9/02; B32B 7/08; B44C 1/17; B23P 17/04; D05B 97/00

(52) U.S. Cl. 5/495; 29/428; 112/475.01; 156/230; 156/93

(57) ABSTRACT

A head placement system for a bed is provided that includes a bed sheet that has an upper surface. The bed sheet has a head edge on one end and a toe edge on an opposite end, and first and second side edges that extend from the head edge to the toe edge. Head indicating indicia is also included and is located on and attached to the upper surface. The head indicating indicia is positioned on the upper surface at a location that designates where a head of a user is located when sleeping on the bed.

### FIELD OF THE INVENTION

The present invention relates generally bed sheets having indicia. More particularly, the present application involves a system and method for placement of a head indicating indicia onto a bed sheet that can be used to assist a user in properly orienting the bed sheet with respect to the head of the bed when making up the bed.

### BACKGROUND

Bed sheets such as bottom sheets, top sheets, and covers are commonly employed in a bed. Bed sheets are often not symmetrical or have specific top and bottom surfaces so that they must be oriented properly when being applied to the bed. The toe end of the bed sheet may be configured differently from the head end of the bed sheet in some instances. A person making a bed thus expends a significant amount of time and energy to distinguish the upper surface of the bed sheet and to determine which end of the bed sheet should be located at the head of the bed.

Prior systems for placing indicia on bed sheets involved the manufacture of bed sheets that had colored yarn incorporated into the hem of the bed sheet. The color of the yarn instructed the user as to the size of the bed sheet so that the user can retrieve a correctly sized bed sheet when making up a bed. However, such indicia cannot be applied by a user or provide insight as to the orientation of the bed sheet on the bed or as to the proper upper surface of the bed sheet. A different indication system in use for making a bed includes the provision of a center indicator onto the bed sheet that is aligned with a corresponding center indicator on a head board or base board of a bed. Once aligned, an equal amount of the bed sheet will be draped over the left side of the bed as the right side of the bed. However, such a system requires a head board or base board be present, requires a mark be made on these portions of the bed, and does not provide insight as to other items such as which surface of the bed sheet is the top surface. Further, such a system requires an equal amount of bed sheet be placed on both the right and left hand sides of the bed and does not account for the possibility that a user or users of a bed would want more or less covers available on different sides during use. Also, such a system requires a user purchase a new bed sheet that incorporates indicia associated with such a system as opposed to using his or her existing bed sheets. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a top plan view of a head placement system with a bed sheet having a head indicating indicia thereon in accordance with one exemplary embodiment.

FIG. 2 is a top plan view of a mattress showing the location of the user with respect to the mattress when using the mattress in accordance with one exemplary embodiment.

FIG. 3 is a top plan view of the bed sheet of FIG. 1 located onto the mattress of FIG. 2 and having a user located thereon.

FIG. 4 is a cross-sectional view taken along line 3-3 of FIG. 3.

FIG. 5 is a top plan view of a head placement system in accordance with another exemplary embodiment.

FIG. 6 is a top plan view of a head placement system in accordance with yet another exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a head placement system 10 that functions to instruct a user 26 as to the correct orientation and placement of a bed sheet 12 with respect to the head of a bed 66. The user 26 can thus make up the bed 66 in a faster and more efficient manner since the proper orientation and placement of the bed sheet 12 on the bed 66 is readily apparent. Head indicating indicia 24 is located on the upper surface 14 of the bed sheet 12 to instruct the user 26 as to which side of the bed sheet 12 is the upper surface 14, and to instruct the user 26 as to which edge of the bed sheet 12 it to be positioned adjacent a head board 72 of the bed 66. The bed sheet 12 may be symmetrical or the top portion of the bed sheet 12 may be constructed differently than the bottom portion of the bed sheet 12 thus making it desirable to properly orient the bed sheet 12 on the bed 66. In a further exemplary embodiment, the location of the head indicating indicia 24 provides a reference point to the user 26 as to where the user's head 28 will be located during use of the bed 66. Pillows 76 can thus be placed in relation to the head indicating indicia 24 in order to more efficiently and accurately make up the bed 66 after use.

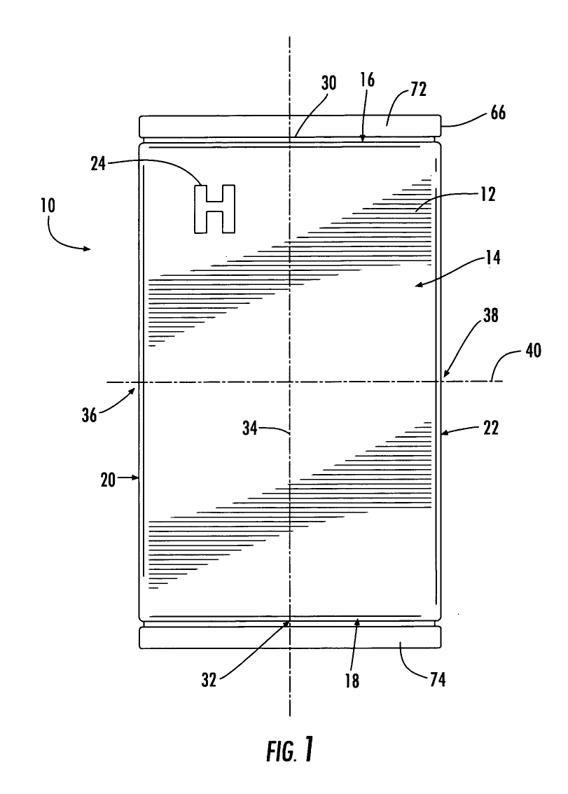

A head placement system 10 shown in accordance with one exemplary embodiment is illustrated in FIG. 1. The head placement system 10 includes a bed sheet 12 that is incorporated into a bed 66 that may have a head board 72 and a foot board 74, although it is to be understood that the bed 66 need not have a foot board 74 and/or head board 72 in other embodiments. The bed sheet 12 has an upper surface 14 that faces generally towards the ceiling of the room into which the bed 66 is located. It is to be understood; however, that certain portions of the upper surface 14 will not face towards the ceiling as portions of the upper surface 14 will be draped over the side of the bed 66 or will be tucked under a mattress 42 and hence inverted. The bed sheet 12 can be a bottom sheet in one exemplary embodiment and may be either a fitted sheet or a flat bed sheet.

The bed sheet 12 has a head edge 16 located on one end and an oppositely disposed toe edge 18 located on an opposite end. A first side edge 20 extends from the head edge 16 to the toe edge 18 and is located on one side of the bed sheet 12. A second side edge 22 is located on the opposite side of the bed sheet 12 and likewise extends from the head edge 16 to the toe edge 18. The head edge 16 is designated the head edge 16 because it is located proximate to the head board 72 where the head 28 of the user is generally located. The toe edge 18 is so designated because it is located proximate to a foot board 74 where the feet of the user 26 are positioned. However, some beds 66 will not include a head board 72 and/or foot board 74. The head edge 16 may thus be located proximate to the portion of the bed 66 where the user's head 28 is located. It is to be understood that the bed sheet 12 can be a fitted bed sheet so that the edges 16, 18, 20 and 22 are located just below an upper surface of a mattress 42 since portions of the bed sheet 12 will wrap around the mattress 42 in order to be retained onto the mattress 42. As such, the edges 16, 18, 20 and 22 may not be in the same plane as the central portion of the upper surface 14 of the bed sheet 12. However, in accordance with other exemplary embodiments, the bed sheet 12 can be provided so that the edges 16, 18, 20 and 22 lay in the same plane as one another and are also located in the same plane as the rest of the bed sheet 12.

Bed sheets 12 are generally made so that one side is longer than the other to result in a rectangular shape. In the embodiment shown, the side edges 20 and 22 are longer than the head and toe edges 16 and 18. The head edge 16 has a midpoint 30 that is located halfway between the first side edge 20 and the second side edge 22. The toe edge 18 has a midpoint 32 that is located halfway between the first side edge 20 and second side edge 22. A longitudinal centerline 34 of the bed sheet 12 extends between the midpoints 30 and 32. In a similar fashion, the first side edge 20 has a midpoint 36 located halfway between the head edge 16 and the toe edge 18, and the second side edge 22 has a midpoint 38 located halfway between the edges 16 and 18. A lateral centerline 40 of the bed sheet 12 extends between midpoints 36 and 38. In other arrangements, the edges 16, 18, 20 and 22 need not have different lengths but may all have the same length. Further, the edges 20 and 22 may be shorter than edges 16 and 18 in other embodiments. In these embodiments, the longitudinal centerline 34 is still located so as to extend proximate to the headboard 72 and thus be arranged in the general direction of the length of the user's body when using the bed 66.

Head indicating indicia 24 is located on the upper surface 14 of the bed sheet 12 in order to instruct the user 26 as to which side of the bed sheet 12 is the upper surface 14 when making up the bed 66. Further, the head indicating indicia 24 instructs the user 26 as to which edge of the bed sheet 12 should be located proximate to the head board 72, or when no head board 72 is present then which edge should be located proximate to the head of the bed 66. Further, in some embodiments the head indicating indicia 24 is located at a position that is vertically directly below the location of the head 28 of the user 26 thus providing the user 26 with a reference point as to where to locate pillows 76 or other objects when making up the bed 66. The head indicating indicia 24 is shown as a letter “H” having a design located therein. However, it is to be understood that this arrangement is only exemplary and that head indicating indicia 24 can be variously configured in accordance with other exemplary embodiments. For example, the head indicating indicia 24 may be any letter, symbol, design, or combination thereof in accordance with different exemplary embodiments. The head indicating indicia 24 only need be capable of instructing the user as to the identification of the upper surface 14 and associated information previously discussed in accordance with certain exemplary embodiments.

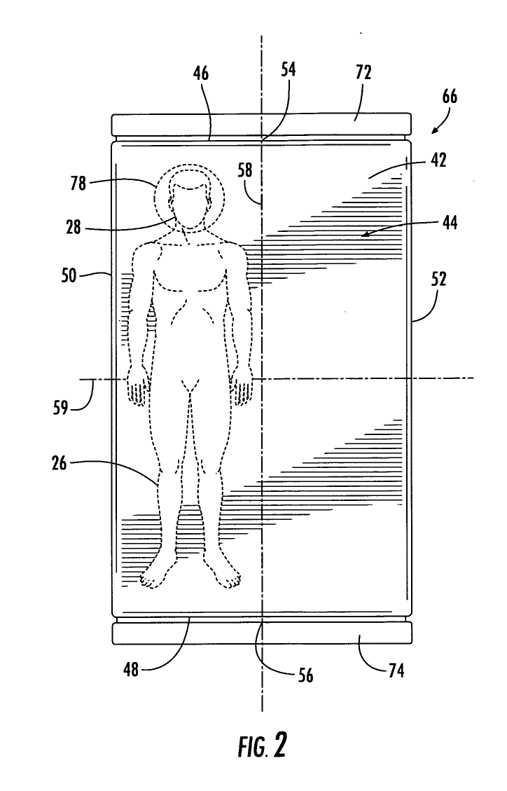

A mattress 42 that can be incorporated into the head placement system 10 is shown with reference to FIG. 2. The mattress 42 has an upper surface 44 that is bound and defined by a head edge 46, toe edge 48, first side edge 50, and second side edge 52. The upper surface 44 faces towards the ceiling of the room into which the bed 66 is located. The head edge 46 is located proximate the head board 72 of the bed 66, and the toe edge 48 is located next to the foot board 74. In arrangements in which the head board 72 is not present, the head edge 46 is located at the head of the bed 66, and the toe edge 48 is located at the portion of the bed 66 where the feet of the user 26 are generally positioned. During use, a user 26 will be positioned above the upper surface 44 and the user's head 28 will be located above a location of the upper surface 44 designated by reference number 78. The upper surface includes a longitudinal centerline 58 that extends from a midpoint 54 of the head edge 46 to a midpoint 56 of the toe edge 48. The longitudinal centerline 58 extends in the general direction that the body of the user 26 will be oriented during use of the bed 66. A lateral centerline 59 bisects the longitudinal centerline 58 and extends through the midpoints of the side edges 50 and 52

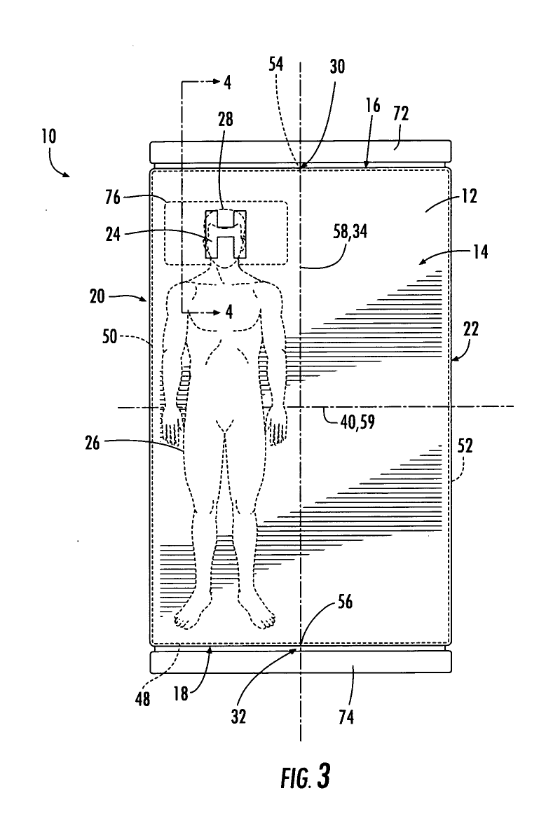

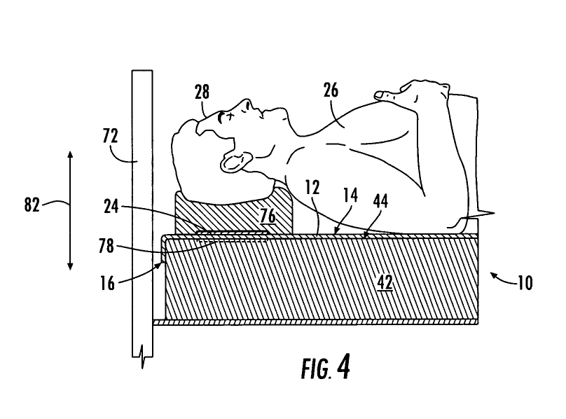

The bed sheet 12 can be placed on top of the mattress 42 as illustrated in FIGS. 3 and 4. The vertical direction 82 is denoted by reference number 82 in FIG. 4. The bed sheet 12 is a bottom sheet and directly contacts the upper surface 44 of the mattress 42. However, it is to be understood that the bed sheet 12 need not directly contact the upper surface 44 in other embodiments. For example, a mattress pad can be located between the upper surface 44 and the bed sheet 12 in other embodiments so that these two components do not directly contact one another. The bed sheet 12 can be arranged with respect to the mattress 42 so that the longitudinal centerlines 34 and 58 overlie one another, and so that the lateral centerlines 40 and 59 likewise are aligned with one another. However, in other arrangements only the longitudinal centerlines 34 and 58 overlie one another while the lateral centerlines 40 and 59 do not overlie one another. The head indicating indicia 24 is located on the upper surface 14 of the bed sheet 12 and is directly contacted by a pillow 76. The head 28 of the user 26 rests on the pillow 76. As such, the head 28 does not directly contact the head indicating indicia 24. The head indicating indicia 24 is located vertically between the head 28 and the bed sheet 12. In this exemplary embodiment, the head 28 is located vertically directly above the head indicating indicia 24 during use of the bed 66 when sleeping. The location 78 of the mattress 44 is likewise vertically located directly under the head 28 when the user 26 uses the bed 66. The head indicating indicia 24 may be spaced from the longitudinal centerlines 34 and 58 some distance so that the head indicating indicia 24 is not located on the longitudinal centerlines 34 and 58. The pillow 76 may be located directly above the head indicating indicia 24 during use of the bed 66, and may be located directly above the head indicating indicia 24 upon making up the bed 66 but before use of the bed 66 when sleeping. In other arrangements, the head 28 of the use 26 can directly contact the head indicating indicia 24 when using the bed 66 while sleeping.

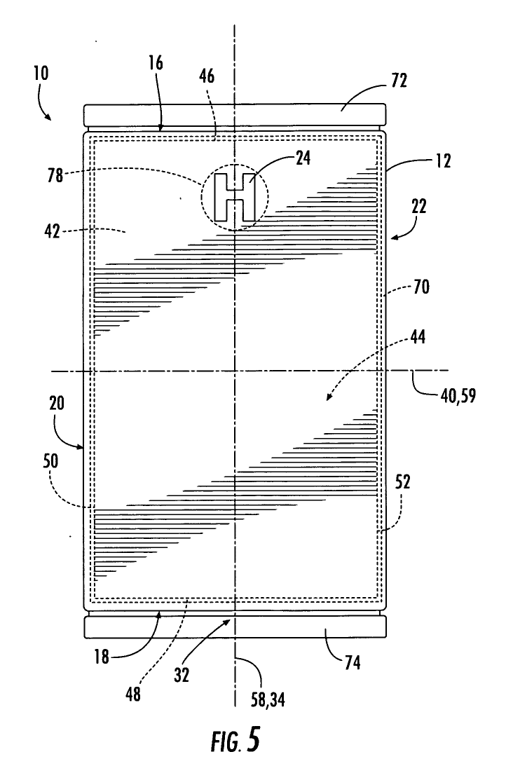

FIG. 5 illustrates an alternative exemplary embodiment in which the bed sheet 12 is a top sheet of the bed 66. The head indicating indicia 24 may thus be visible upon making up the bed 66, although it is to be understood that an additional cover or pillows 76 could be placed onto the head indicating indicia 24 to obscure same after making up the bed 66. The bed 66 includes a bottom sheet 70 that is located on top of and directly contacts the upper surface 44. Location 78 signifies a portion of the mattress 44 above which the head 28 of the user 26 will be located during use of the bed 66. The head indicating indicia 24 is located directly above the location 78 when the bed sheet 12 is placed onto the bed 66 when the bed 66 is made. During use of the bed, the user 26 may pull the bed sheet 12 down and position himself or herself between the sheet 12 and bottom sheet 70. As such, the head indicating indicia 24 will not be located above the head 28 of the user 26 during use of the bed 66. However, the head indicating indicia 24 will be located above location 78 when the bed sheet 12 is placed into the position when the bed 66 is made. The head indicating indicia 24 may thus function to demarcate the appropriate orientation of the bed sheet 12 with respect to the head of the bed as previously discussed.

The head indicating indicia 24 may be located up to 3 feet from the head edge 16. In other arrangements, the head indicating indicia 24 may be located from 3 to 6 inches, from 6 to 12 inches, from 1 foot to 2 feet, or up to 5 feet from the head edge 16. Further, the head indicating indicia 24 may be located on the longitudinal centerline 34 or may be spaced up to 6 inches, from 6 inches to 12 inches, up to 2 feet, or up to 5 feet from the longitudinal centerline 34.

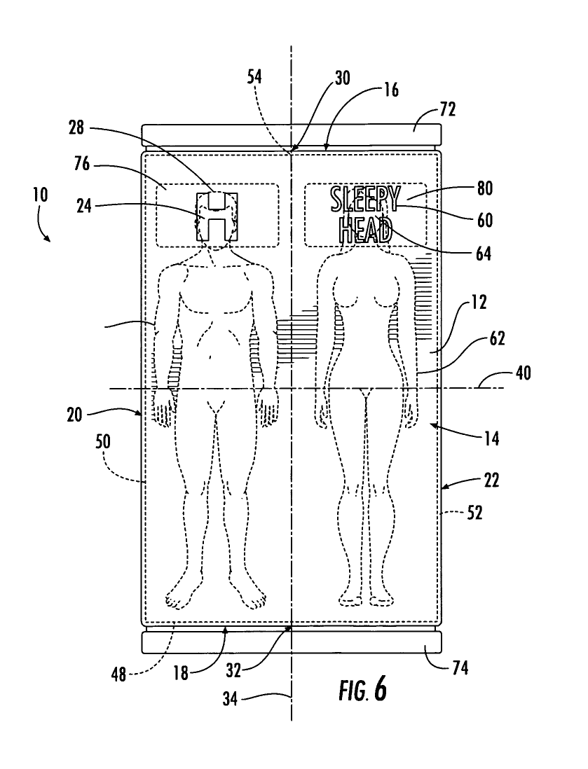

FIG. 6 illustrates an alternative exemplary embodiment in which a second head indicating indicia 60 is located on the upper surface 14 of the bed sheet 12. The first indicating indicia 24 can be used to designate the location of the head 28 of the user 26 in the manner previously discussed. The second head indicating indicia 60 may likewise be positioned on the upper surface 14 so as to designate the location of the head 64 of the second user 62 when using the bed 66. In different arrangements, the second head indicating indicia 60 may be used to designate the location of the bed sheet 12 when made up such that this location is directly vertically above a portion of the mattress 42 that is directly vertically below the head 64 of the second user 62 when the second user 62 is sleeping in the bed 66. The second head indicating indicia 60 can be used and configured in a manner similar that of the first head indicating indicia 24 as discussed above and a repeat of this information is not necessary.

The second head indicating indicia 60 can be spaced a distance from the longitudinal centerline 34 such that the indicia 60 is not located on the longitudinal centerline 34 and such that the indicia 24 and 60 are on opposite sides of the longitudinal centerline 34. The indicia 60 may be located the same distance from the head edge 16 as the first indicia 24, or the second head indicating indicia 60 may be located a different distance from the head edge 16 than the first head indicating indicia 24. The indicia 24 and 60 can both be used to ascertain the upper surface 14 of the bed sheet 12 and to properly orient the bed sheet 12 with respect to the head of the bed 66. Further, the indicia 24 and 60 may include symbols, letters, or pictures that are different from one another so that each indicia 24 and 60 designates a particular user 26 and 62. As such, one will know when making up the bed 66 where to put the particular pillows 76 or 80 that correspond to the particular user 26 and 62 thus allowing the bed 66 to be made up and used in a more efficient manner.

The head indicating indicia 24 can be located in the head placement system 10 so that the head indicating indicia 24 is visible when viewing the bed 66 and/or is located vertically directly above the upper surface 44 of the mattress 42 when the bed sheet 12 is located on the bed 66. Although described as being visible, in other arrangements a cover, blanket, pillow or other object may be placed on top of the head indicating indicia 24 upon making up the bed 66 thus obscuring the head indicating indicia 24 from sight once the bed 66 is made up after use. However, it is to be understood that other arrangements are possible in which the head indicating indicia 24 is visible even after the bed 66 is made.

The head placement system 10 may be constructed by first providing a bed sheet 12 that has an upper surface 14. The bed sheet 12 may be a fitted bed sheet or a flat bed sheet or may be a symmetrical or non-symmetrical bed sheet. The user can next place the bed sheet 12 onto the mattress 42 or bed 66 in the proper manner or orientation upon making up the bed 66. If the bed sheet 12 is a bottom sheet, the bed sheet 12 can be placed onto a mattress 42 in its normal position. If the bed sheet 12 is a top sheet, the bed sheet 12 can be placed onto the bottom sheet 70 or other part of the bed 66 as one would normally do when making up the bed 66 so that the bed sheet 12 is in the position it would normally be in when the bed 66 is made up. When the bed sheet 12 is a top sheet, the bed sheet 12 is not covered by pillows, blankets, or other portions of the bed 66.

Next, the user 26 may mark a location on the bed sheet 12 where the head 28 of the user 26 will be positioned when sleeping. The marked location may be vertically directly above the portion 78 of the upper surface 44 of the mattress 42 where the head 28 of the user 26 will be located when sleeping. The location marked on the bed sheet 12 will thus be proximate to the head of the bed 66. The marking by the user 26 may be made in a variety of manners. For example, the user 26 may use a piece of notepaper having weakened adhesive, a pencil dot indicator, or may use a safety pin to designate the desired location. In other arrangements, the marking may be just a visual notation by the user 26 without any physical placement or touching of the bed sheet 12. As such, the marking may be either physically marking the location on the bed sheet 12 or marking by just visually noting the desired location.

The user may then remove the bed sheet 12 from the bed and affix the head indicating indicia 24 onto the marked location on the top surface of the bed sheet 12. If a physical marker was applied to the bed sheet 12, the physical marker may or may not be removed before the affixing step. The head indicating indicia 24 may be a printed emblem on transfer paper. In this regard, the user 26 can place the bed sheet 12 onto a hard surface or under a pillowcase or similar article located between the bed sheet 12 and the hard surface. The user may then properly locate the transfer paper onto the marked located on the bed sheet 12 and apply an iron, with or without steam, to the transfer paper using circular motions for two or three minutes. The transfer paper can then be removed and the head indicating indicia 24 will be properly affixed to the upper surface 14 of the bed sheet 12 at the desired location. The head indicating indicia 24 may be made of 100% organic cotton material and may be bonded with machine washable adhesives to ensure proper attachment after multiple laundry cycles. In other arrangements, the head indicating indicia 24 may be a synthetic material, or may be a combination of synthetic and organic materials. Although described as being removed from the bed 66 in order to affix the head indicating indicia 24 thereon, the bed sheet 12 need not be removed from the bed 66 in other embodiments and the head indicating indicia 24 may be affixed to the upper surface 14 while the bed sheet 12 is located on the bed 66.

Although described as being located directly vertically below the head 28 of the user 26, the head 28 need not be actually located directly vertically above the head indicating indicia 24 in certain exemplary embodiments. In these instances, the head indicating indicia 24 will be at least proximately located directly under the head 28 of the user 26 so that the proper orientation of the bed sheet 12 with respect to the bed 66 can be realized. This arrangement is also true should the bed sheet 12 be a top sheet. Here, the location 78 of the upper surface 44 of the mattress 42 is not located vertically directly under the head 28 of the user 26 when sleeping but is located proximately directly vertically under the head 28. However, the location 78 is still located vertically directly under the head indicating indicia 24 when the bed 66 is made. The head 28 of the user 26 may be located directly above a portion of the upper surface 14 of the bed sheet 12 that is up to 6 inches, from 6 to 12 inches, or up to 2 feet from the head indicating indicia 24. As such, the head 28 of the user 26 may be located some distance from the head indicating indicia 24 so as not to be located completely vertically above the head indicating indicia 24 in certain embodiments. The head indicating indicia 24 may thus be spaced from all of the edges 16, 18, 20 and 22 of the bed sheet 12 such that the head indicating indicia 24 is not located along any of the edges. Further, the head indicating indicia 24 may be a single piece of indicia and not multiple pieces of indicia in certain exemplary embodiments. Further, markings or indicia need not be made on any other portions of the bed 66, such as the head board 72 or foot board 74. The entire applied indicia may be limited to only the upper surface 14 of the bed sheet 12 and no other portion of the bed 66.

The head placement system 10 may be an aftermarket item in that the head placement system 10 can be used with bed sheets 12 of any make or manufacture. However, in certain embodiments the head indicating indicia 24 can be applied by a manufacturer of the bed sheet 12 and be sold to a consumer with the indicia 24 all ready applied thereon. The head placement system 10 can be used by children who are first learning to make their beds. Also, elderly who may have various medical frailties may also benefit upon use of the head placement system 10 as it will facilitate easier making of their beds. Additionally, other people will likewise benefit such as those having arthritis and eyesight impairment or individual with other physical handicaps or learning differences. For example, the fact that the head indicating indicia 24 may be raised above the upper surface 14 since it is located on the upper surface 14 may allow a blind person to feel the head indicating indicia 24 and allow him or her to properly position the bed sheet 12 on the bed 66. However, it is to be understood that the head placement system 10 can be used by any person making up a bed 66 and is not so limited to a particular type of user.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A head placement system for a bed, comprising:
a bed sheet having an upper surface, wherein the bed sheet has a head edge on one end and a toe edge on an opposite end, wherein the bed sheet has a first side edge that extends from the head edge to the toe edge, and wherein the bed sheet has a second side edge that extends from the head edge to the toe edge; and
a head indicating indicia located on and attached to the upper surface, wherein the head indicating indicia is positioned on the upper surface at a location that designates where a head of a user is located when sleeping on the bed.

2. The head placement system as set forth in claim 1, wherein the bed sheet is a bottom sheet and wherein the head of the user is located directly vertically above the head indicating indicia such that the head indicating indicia is located between the bed sheet and the head of the user.

3. The head placement system as set forth in claim 1, wherein the head indicating indicia is an iron on emblem.

4. The head placement system as set forth in claim 3, wherein the head indicating indicia is the letter H.

5. The head placement system as set forth in claim 1, wherein a longitudinal centerline of the bed sheet is located at the midpoint of the head edge and at the midpoint of the toe edge, wherein the longitudinal centerline extends from the midpoint of the head edge to the midpoint of the toe edge, and wherein the head indicating indicia is spaced from the longitudinal centerline such that the head indicating indicia is not located on the longitudinal centerline.

6. The head placement system as set forth in claim 5, further comprising a mattress that has an upper surface having a head edge on one end and a toe edge on an opposite end, wherein the upper surface of the mattress has a first side edge that extends from the head edge to the toe edge, and wherein the upper surface of the mattress has a second side edge that extends from the head edge to the toe edge, wherein the upper surface of the mattress has a longitudinal centerline that is located at the midpoints of the head edge and the toe edge, wherein the longitudinal centerline of the upper surface of the mattress extends from the midpoint of the head edge to the midpoint of the toe edge;
wherein the bed sheet is located on the upper surface of the mattress; and
wherein the head indicating indicia is located above a location of the upper surface of the mattress that is equal distant from the longitudinal centerline of the upper surface of the mattress and the first side edge of the upper surface of the mattress.

7. The head placement system as set forth in claim 5, further comprising:
a second head indicating indicia located on and attached to the upper surface, wherein the second head indicating indicia is positioned on the upper surface at a location that designates where a head of a second user is located when sleeping on the bed;
wherein the second head indicating indicia is spaced from the longitudinal centerline such that the second head indicating indicia is not located on the longitudinal centerline, wherein the first head indicating indicia and the second head indicating indicia are located on opposite sides of the longitudinal centerline;
wherein a lateral centerline of the bed sheet is located at the midpoint of the first side edge and at the midpoint of the second side edge, wherein the longitudinal centerline extends from the midpoint of the first side edge to the midpoint of the second side edge, and wherein the first head indicating indicia and the second head indicating indicia are located on the same side of the lateral centerline.

8. A method for affixing indicia onto a bed sheet, comprising the steps of:
providing a bed sheet having an upper surface;
placing the bed sheet on a bed;
marking a location on the bed sheet where a head of a user will be located above when using the bed sheet;
removing the bed sheet from the bed; and
affixing a head indicating indicia onto the upper surface of the bed sheet at the location noted by the marking step.

9. The method as set forth in claim 8, wherein the head indicating indicia is an iron on emblem and wherein the affixing step is accomplished by ironing the iron on emblem onto the upper surface of the bed sheet.

10. The method as set forth in claim 8, wherein the affixing step is accomplished by sewing the head indicating indicia onto the upper surface of the bed sheet.

11. The method as set forth in claim 8, wherein the marking step is accomplished by placing a safety pin into the bed sheet at the location on the bed sheet where the head of the user will be located above when using the bed sheet, and wherein the safety pin is removed from the bed sheet during the affixing step.

12. A method for placing indicia onto a bed sheet, comprising the steps of:
providing a bed having a mattress, wherein the mattress has an upper surface having a head edge on one end and a toe edge on an opposite end, wherein the upper surface of the mattress has a first side edge that extends from the head edge to the toe edge, and wherein the upper surface of the mattress has a second side edge that extends from the head edge to the toe edge, wherein a perimeter of the upper surface of the mattress is defined by the head edge, the toe edge, the first side edge, and the second side edge;
placing a bed sheet on top of the mattress in a position the bed sheet is located upon making up the bed, wherein the bed sheet has an upper surface that is located above the upper surface of the mattress and faces away from the upper surface of the mattress; and
affixing a head indicating indicia onto the upper surface of the bed sheet so that when the bed sheet is located on the bed upon making up the bed the head indicating indicia is above the same portion of the mattress below which a head of a user is located during use of the bed.

13. The method as set forth in claim 12, wherein the placing step is performed before the affixing step, and further comprising the steps of:
marking a location on the bed sheet when the bed sheet is positioned on top of the mattress in the placing step such that the location marked is at a location above the upper surface of the mattress where the head of the user is located during use of the bed; and
removing the bed sheet from the mattress, and then subsequently performing the affixing step.

14. The method as set forth in claim 12, wherein the bed sheet is a bottom sheet and directly contacts the upper surface of the mattress during the placing step.

15. The method as set forth in claim 12, wherein the bed sheet is a top sheet and does not directly contact the upper surface of the mattress during the placing step.

16. The method as set forth in claim 12, wherein the head indicating indicia is an iron on emblem and wherein the affixing step is accomplished by ironing the iron on emblem onto the upper surface of the bed sheet.
